(19) United States
(12) Patent Application Publication
(10) Pub. No.: US 2012/0266969 A1
(43) Pub. Date: Oct. 25, 2012

(54) Pressure Relief Tool and Method for Closed System

(75) Inventor: Jack Albert Merchant, Peoria, IL (US)

(73) Assignee: CATERPILLAR, INC., Peoria, IL (US)

(21) Appl. No.: 13/092,316

(22) Filed: Apr. 22, 2011

(51) Int. Cl. F15D 1/00; F16K 13/00

(52) U.S. Cl. 137/14; 137/511

(57) ABSTRACT

Systems, methods and tools are disclosed for releasing pressure from closed systems. For example, in a SCR system, diesel emission fluid (DEF) can become over pressurized as it is pumped between a DEF pump and a DEF injector. A manifold may be disposed between the pump and injector. The manifold or passageway that communicates the DEF between the pump and injector includes a service port. A plug is disposed between the DEF passage and the service port or on a seat disposed between the DEF passage and the service port. A specially designed tool is employed to dislodge the plug from the seat and release pressure in the DEF passage through the tool and, optionally, through a drain hose connected to a distal end of the tool.

### TECHNICAL FIELD

This disclosure relates generally to diesel emission fluid (DEF) injection systems and, more specifically, to pressure relief systems for safely releasing pressure trapped in a manifold, or between a DEF pump and a DEF injector.

### BACKGROUND

Internal combustion engines, including diesel engines, gasoline engines, gaseous fuel-powered engines, and other engines may exhaust a complex mixture of air pollutants. The air pollutants may be composed of gaseous and solid compounds, including particulate matter, nitrogen oxides (NOx), and sulfur compounds. Due to heightened environmental concerns, exhaust emission standards have become increasingly stringent. The amount of pollutants emitted from an engine may be regulated depending on the type, size, and/or class of engine. One method implemented by engine manufacturers to comply with the regulation of NOx exhausted to the environment has been to implement a strategy called selective catalytic reduction (SCR).

SCR is a process by which a gaseous or liquid reductant (e.g., urea or ammonia) is added to the flow of exhaust from an engine. The combined flow is then absorbed onto a catalyst. The reductant reacts with NOx in the flow of exhaust to form nitrogen and water (N2 and H2O). SCR may be more effective when a ratio of NO to NO2 in the flow of exhaust supplied to the SCR catalyst is about 50:50. Some engines, however, may produce a flow of exhaust having a NO to NO2 ratio of approximately 95:5. In order to increase the relative amount of NO2 to achieve a NO to NO2 ratio of closer 50:50, a diesel oxidation catalyst (DOC; not shown in FIG. 1) may be located upstream of the SCR catalyst to convert NO to NO2.

Turning to FIG. 1, an example of an engine aftertreatment system incorporating SCR technology is shown. The basic diesel engine design and operation does not change with the addition of SCR equipment. SCR components are installed downstream of a diesel particulate filter 11, which forms part of an exhaust system for the engine 12. The fuel tank 13 and fuel injection system 14 are also shown, schematically. While the filter 11 removes soot and other particulate matter, SCR transforms the NOx vapors into nitrogen and water. Specifically, an SCR system uses a diesel exhaust fluid (DEF) supplied in the tank 20. The DEF tank 20 is in communication with a DEF pump 15 which, in turn, is in communication with an injector 16. DEF is typically a solution of about two thirds water and one third urea. The filtered exhaust exits the filter 11, is combined with DEF at the injector 16 and is passed through an SCR catalyst chamber 17. When DEF is introduced into the hot SCR catalyst chamber 17, the DEF turns to ammonia, which reacts with the NOx, turning it into nitrogen gas and water vapor. In some applications, DEF is injected through the injector 16 (or doser) at a rate of about two gallons of DEF to about 100 gallons of diesel fuel.]

Pressure relief valves are known in the art. See, e.g., WO2011001256, which discloses a spring-biased pressure relief valve for a tank assembly or US20080148716, which discloses a spring-biased relief valve for an exhaust system. What is needed is safe and convenient pressure relief mechanisms and methods that can be used in situations when a pressure relief valve cannot.

### SUMMARY OF THE DISCLOSURE

In one example, a diesel emission fluid (DEF) injector pressure release system is disclosed. The DEF injector pressure release system includes a DEF passage which communicates DEF to a DEF injector. The DEF passage is in communication with a service port. A plug is disposed between the DEF passage and the service port. As explained below, the plug may be dislodged from the service port/DEF passage opening to release pressure, using a specialized tool as described below.

In another example, a pressure release system is disclosed. The pressure release system may include a fluid passage which communicates pressurized fluid between a pump and an injector. The passage is in communication with a service port. A plug is disposed between the passage and the service port.

In yet another example, a method for relieving pressure from a diesel exhaust fluid (DEF) system is disclosed. The method includes providing a dislodgeable plug within a DEF passage which communicates pressurized DEF to a DEF injector. The method also includes providing a service port in communication with the plug. The method further includes displacing the plug using a service tool inserted into the service port and releasing pressure from the DEF passage through the displacement of the plug.

In another example, a service tool is disclosed which is useful for releasing pressure from a pressurized passage or manifold. The disclosed service tool includes a body with a tip connected to a distal end of the body. The tool also may include a hollow passageway extending through the body and the tip. The tip may be configured for insertion into a service port of a DEF manifold and the tip may be configured to displace the plug within the DEF manifold. The tip and hollow passageway may also be configured to allow pressure to be communicated through the service tool and out the service port.

### BRIEF DESCRIPTION OF THE DRAWINGS

FIG. 1 illustrates, schematically, an engine and exhaust system equipped with an SCR system.

FIG. 2 is a partial view of a manifold and ball plug isolating a fluid passageway from a service port.

FIG. 3 is a perspective view of a disclosed service tool used to dislodge the ball plug shown in FIG. 2 for the release of pressure through the service tool and service port.

FIG. 4 illustrates the service tool as inserted into the service port and engaging the ball plug thereby dislodging the ball plug and removing the seal between the fluid passageway and service port for the release of pressure through the hollow service tool.

FIG. 5 is a partial view of a manifold and ball plug in a normal condition where the ball plug blocks communication between the fluid passageway and service port.

FIG. 6 is another partial and sectional view of a manifold and service tool as the service tool is being inserted into the service port prior to engagement with the ball plug.

FIG. 7 is another partial and sectional view of a manifold, service tool, ball plug and drain hose wherein the service tool is in position to engage and dislodge the ball plug into the manifold passageway.

FIG. 8 is yet another partial sectional view of a manifold, service tool, drain hose and ball plug wherein the service tool has been inserted far enough into the service port to have engaged the ball plug, moved the ball plug into the manifold passageway thereby providing a release of pressure from the manifold passageway, around the ball plug, through the hollow passageway of the service tool and out the drain hose.

### DETAILED DESCRIPTION OF THE PRESENTLY PREFERRED EMBODIMENTS

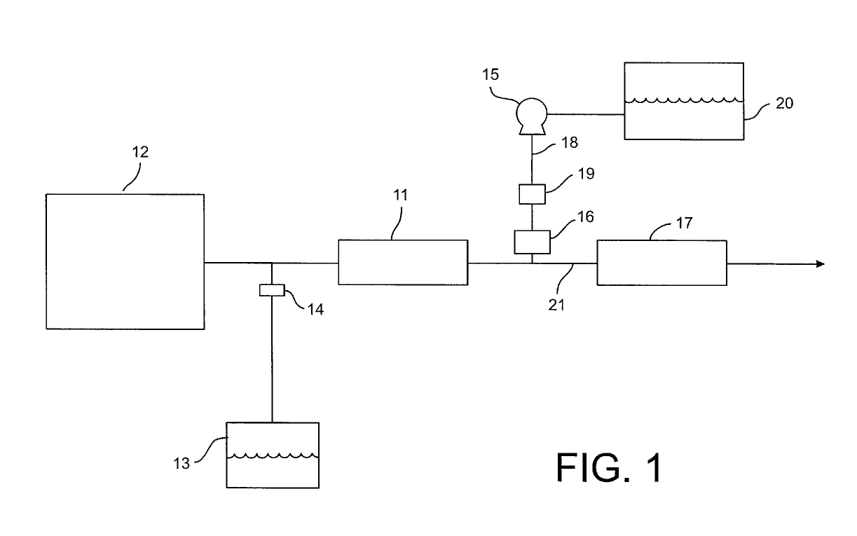

One problem associated with the SCR system illustrated in FIG. 1 lies in the pressurized passage 18 and manifold 19 disposed between the pump 15 and injector 16. The DEF injection system 15, 16, 18 and 19 is a pressurized system that holds pressure in the passage 18 between the pump 15 and the injector 16. Under normal operation, the pressure is used to facilitate the spray the DEF into the exhaust stream, shown at 21. The spray may be triggered by a solenoid in the injector 16 and the injector 16 may include a mechanism for further pressurizing the DEF. In the rare event of a system malfunction, pressure in the passage 18 cannot be relieved through the injector 16. Because the communication between the pump 15, passage 18, manifold 19, injector 16 and exhaust 21 is closed, meaning there is little or no leakage, there is a need to safely relieve pressure buildup in the passage 18, manifold 19 and/or and injector 16 in a manner that does not present a hazard to the mechanic.

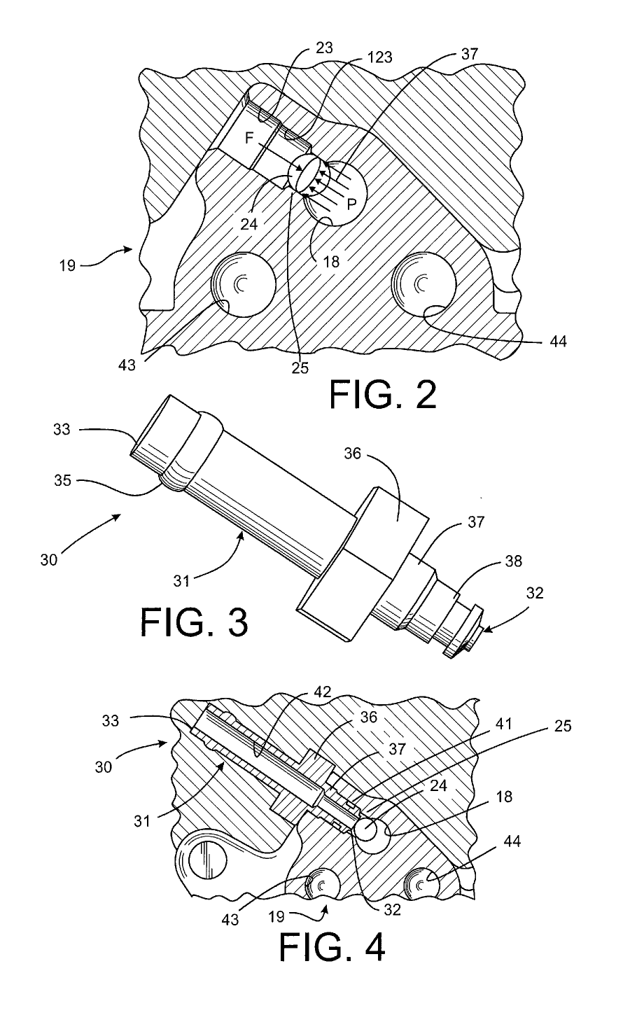

Returning to FIG. 1, pressure can accumulate in the passage 18, manifold 19 and/or injector 16 for a variety of reasons. The pressures generated are illustrated schematically in FIG. 2 which shows a partial view of the manifold 19 and the passage 18. The passage 18 is isolated from a service port 23 by a ball 24, also referred to as a pressure relief ball or a pressure relief ball plug. When the ball 24 is positioned on the seat The ball 24 is capable of providing a seal between the passageway 18 and the service port 23 despite substantial pressures. For example, a typical ball 24 will have a diameter of about 6.35 mm or a cross sectional area of 3.17×10⁵ m². If the pressure in the passageway 18 is about 1 MPa, the force generated on the ball 24 (F=P×A) is about 31.7N. Obviously, if there is a malfunction, such as blockage, the force in the passageway 18 can be substantially greater than 31.7N.

Because the pressure must be released for service or maintenance, a service tool 30 is illustrated in FIGS. 3-4. The tool 30 may include an elongated body 31 with a proximal end 32 having a first opening 28 for engaging the ball 24 and a distal end 33 with a second opening 29 for receiving a drain hose 47 as illustrated below in FIGS. 6-8. The tool 30 may include a hose barb 35 and a flange 36, that may be geometrically shaped so it can be used with a wrench or other hand tool. The optional threaded section 37 screws into the corresponding optional threaded section 123 of the service port 23. Because a standard torque applied on M10×1.5 threads may generate a force of about 44 kN, the engagement between the service tool 30 and the service port 23 is stronger than the typical pressure imposed upon the ball 24 in the direction of the arrows 37 as illustrated in FIG. 2. However, alternative embodiments include configurations wherein the threaded sections 123 may be omitted, for example in one embodiment the ball plug 24 can be dislodged using hand pressure. Returning to FIG. 3, recess 38 towards the proximal end 32 of the tool 30 accommodates a seal, such as an O-ring.

Returning to FIG. 4, an O-ring 41 can be seen in the recess 38 (FIG. 3). The tool 30 also includes a hollow passageway 42 that extends from the distal end 33 to the proximal end 32 of the tool 30. The hollow passageway 42 provides communication between the manifold passageway 18 and the atmosphere or drain hose as illustrated below in connection with FIGS. 6-8.

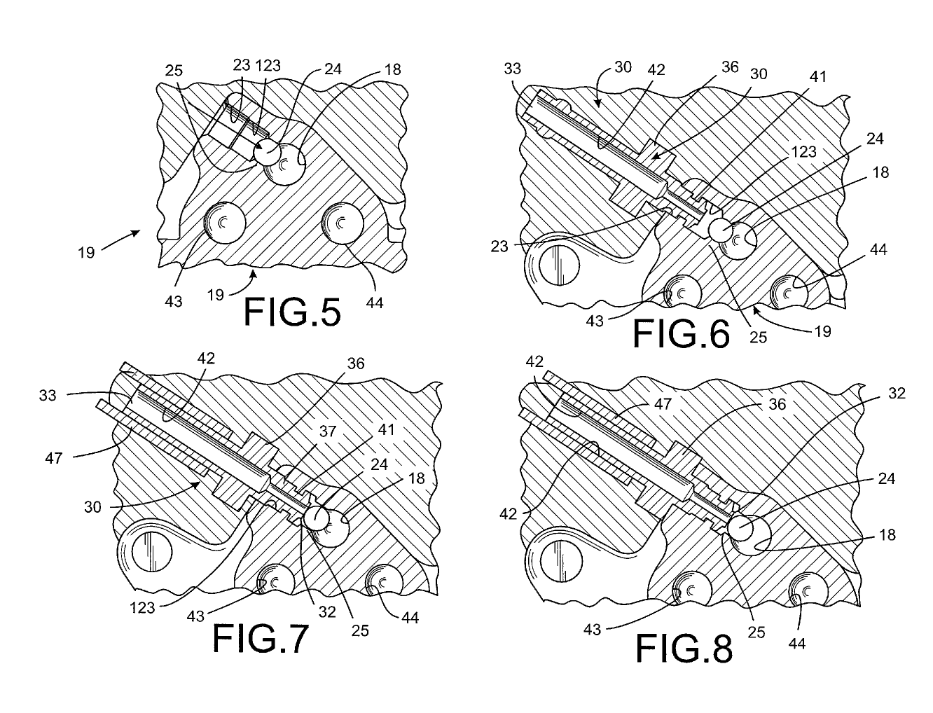

Returning to FIG. 5, the manifold 19 and ball 24 are shown in a normal condition. The passages shown at 43, 44 may be coolant passages. In FIG. 6, the tool 30 is being inserted into the service port 23 prior to engagement with the ball 24. In FIG. 7, an optional drain hose 47 has been coupled to the distal end 33 of the tool 30. Obviously, the drain hose 47 can be substantially longer than shown and may be long enough to reach a safe receptacle for receiving the DEF. In FIG. 7, the tool 30 has been inserted far enough into the service port 23 to enable the threaded sections 37 and 123 to be threadably coupled together. The distal end 32 of the tool 30 has engaged the ball 24 but not dislodged the ball 24 from the passage between the passageway 18 and the service port 23. In FIG. 8, the tool 30 has been rotated a sufficient number of turns so the proximal end 32 of the tool 30 has engaged and dislodged the ball 24 so the ball 24 is disposed within the passage 18. Pressure may be released around the ball and down through the hollow passageway 42 of the tool 30.

### INDUSTRIAL APPLICABILITY

Systems are disclosed for relieving pressure from closed systems or apparatuses where little or no leakage is present. Specifically, in any system with an engine 12 or generator that is equipped with an SCR system (see 14-19 of FIG. 1), blockage or another malfunction can occur resulting in a build up of pressure in the manifold or between the pump 15 that pumps DEF from the reservoir 14 to the DEF injector 16. A safe, convenient and economical pressure release system is disclosed in the form of drilling a service port 23 or other similar passage in the manifold 19. If a malfunction occurs and pressurized DEF accumulates in the passageway 18, the disclosed tool 30 may be used by inserting the tool 30 into the service port 23 and screwing the tool 30 in place by way of the threads disposed inside the service port 23 at 123 and the threads disposed along the section 37 of the tool 30. The geometrically shaped flange 36 can facilitate the threaded coupling between the tool 30 and the manifold 19. The distal end 32 of the tool 30 eventually engages the ball 24, thereby pressing the ball 24 off of the seat disposed between the DEF passage 18 and the service port 23. When this happens, pressurized DEF is released around the ball and down through the hollow passageway 42 of the tool 30. A drain hose 47 may be used to deposit the DEF in an appropriate receptacle.

As a result, a convenient method is disclosed for relieving pressure from a diesel exhaust fluid (DEF) system. The method includes providing a plug 24 within a DEF passage 18 which communicates pressurized DEF to a DEF injector 16. The method also includes providing service port 23 in communication with the plug 24. The service port and the DEF passage 18 may form a seat for accommodating the plug 24, which may be a ball plug 24. The method also includes displacing the plug 24 using a service tool 30 inserted into the service port 23 and releasing pressure from the DEF passage 18 through the displacement of the plug 24, which may include relieving pressure through a hollow passageway 42 in the service tool 30.

What is claimed is:

1. A diesel emission fluid (DEF) injector pressure relief system comprising:
a DEF passage which communicates DEF to a DEF injector, the DEF passage in communication with a seat disposed between the DEF passage and a service port; a plug disposed on the seat between the DEF passage and the service port.

2. The DEF injector pressure relief system of claim 1, further including an at least partially hollow service tool configured for insertion into the service port, wherein the service tool is configured to displace the plug from the seat when the service tool is inserted into the service port.

3. The DEF injector pressure relief system of claim 2, wherein the service tool provides fluid communication between the DEF passage and a drain hose.

4. The DEF injector pressure relief system of claim 1, wherein the plug is disposed in a manifold which is separable from the DEF injector.

5. The DEF injector pressure relief system of claim 1, wherein the plug is disposed in a manifold that is disposed between a DEF pump and the DEF injector, the manifold being separable from the DEF pump and the DEF injector.

6. The DEF injector pressure relief system of claim 2 wherein the service tool includes an elongated hollow body with a proximal end and a distal end, the proximal end of the service tool including a first opening for partially receiving the plug, the distal end including a second opening for connection to a drain hose.

7. The DEF injector pressure relief system of claim 6 wherein the proximal end of the service tool includes a seal to provide a seal between an outer portion of the proximal end of the service tool and the service port when the proximal end of the service tool is inserted into the service port.

8. The DEF injector pressure relief system of claim 6 wherein the service tool further includes a flange disposed on an outer portion of the service tool between the proximal and distal ends thereof, the flange limiting the ingress of the proximal end of the service tool into the service port.

9. The DEF injector pressure relief system of claim 1 wherein the plug is a ball plug.

10. A method for relieving pressure from a diesel exhaust fluid (DEF) system, the method comprising:
providing a service port in communication with a seat;
providing a DEF passage in communication with the seat, the DEF passage providing pressurized DEF to a DEF injector;
seating a plug on the seat to isolate the service port from the DEF passage;
displacing the plug using a service tool inserted into the service port; and
releasing pressure from the DEF passage through the displacement of the plug.

11. The method of claim 10 wherein the service tool includes an elongated hollow body for communicating pressure through the body and the service port upon dislodgement of the plug with the service tool.

12. The method of claim 11 further including providing fluid communication between the DEF passage and a drain hose through the service tool.

13. The method of claim 10, wherein the plug is disposed in a manifold which is separable from at least one of the injector and the pump.

14. The method of claim 11 wherein the service tool includes an elongated hollow body with a proximal end and a distal end, the proximal end of the service tool including a first opening for partially receiving the plug, the distal end including a second opening for connection to a drain hose.

15. The method of claim 14 wherein the proximal end of the service tool includes a seal to provide a seal between an exterior surface of the proximal end of the service tool and an interior surface of the service port, and the method further includes sealing the exterior surface of the service tool against the interior surface of the service port when the proximal end of the service tool is inserted into the service port.

16. The method of claim 14 further including limiting ingress of the service tool into the service port by providing a flange disposed on an outer portion of the service tool between the proximal and distal ends thereof, the flange having a diameter larger than a diameter of the service port thereby limiting the ingress of the proximal end of the service tool into the service port.

17. The method of claim 10 wherein the plug is a ball plug.

18. A service tool comprising:
a body comprising a proximal end and a distal end;
the proximal end including a first opening;
the distal end including a second opening;
a hollow passageway extending through the body between the first and second openings;
wherein the proximal end is configured for insertion into a service port of a diesel exhaust fluid (DEF) manifold, and
wherein the proximal end is configured to displace a plug within the DEF manifold, and wherein the hollow passageway is configured to allow passage of DEF through the service tool.

19. The service tool of claim 18 wherein the proximal end of the service tool includes a seal to seal the proximal end of the service tool against an inner wall of the service port.

20. The service tool of claim 18 wherein the service tool further includes a flange disposed on an outer portion of the service tool between the proximal and distal ends thereof, the flange limiting the ingress of the proximal end of the service tool into the service port.
